(19) United States
(12) Patent Application Publication
(10) Pub. No.: US 2006/0269836 A1
(43) Pub. Date: Nov. 30, 2006

(54) BATTERY PACK

(75) Inventors: Kenji YAMAMOTO, Osaka (JP); Hirofumi IWAKI, Osaka (JP); Takeshi MUSHIGA, Osaka (JP); Shinichi SUMIYAMA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/420,937

(22) Filed: May 30, 2006

(30) Foreign Application Priority Data
May 30, 2005 (JP) 2005-156945

(51) Int. Cl. H01M 2/02

(52) U.S. Cl. 429/159; 429/176

(57) ABSTRACT

A battery pack includes: a cell assembly including a plurality of parallel arranged cells that are connected to each other through lead pieces; a planar terminal plate having positive and negative output terminals; and an outer case for accommodating the cell assembly, having one open end at which the terminal plate is arranged. In this battery pack, the outer case is a square tubular metal can with a bottom, the open end edge of the metal can is bent inwards to crimp seal the case with the terminal plate, and one or more apertures are formed in a side face of the metal can. This battery pack has improved battery performance and reduced cost due to increased inner volume of cells and reduced number of components. Furthermore, the battery pack secures high safety even in the event of a release of contents from cells.

The present disclosure relates to subject matter contained in priority Japanese Patent Application No. 2005-156945, filed on May 30, 2005, the contents of which is herein expressly incorporated by reference in its entirety.

### BACKGROUND OF THE INVENTION

1. Field of the Invention

The present invention relates to a battery pack, and more particularly to a battery pack made by encasing a cell assembly consisting of a plurality of connected cells in an outer case, with a terminal plate carrying output terminals arranged at one open end of the outer case.

2. Description of the Related Art

A conventional battery pack of this type is made as follows: A plurality of cells are connected to each other using lead pieces to form a cell assembly; positive and negative terminals of the cell assembly are connected to positive and negative output terminals attached to a terminal plate using positive and negative lead pieces; the cell assembly with the terminal plate is inserted into a hollow, square columnar outer case together with an insulating plate and a metal bottom plate; and the edge of the bottom open end of the outer case is bent inwards to crimp seal the case (see, for example, Japanese Patent Publication No. 10-321203).

One example of the same type of battery pack is described with reference to FIG. 5. The battery pack 20 includes: a cell assembly 23 consisting of a plurality of parallel arranged cells 21 that are connected in series using a connection member 22 made of lead pieces and insulating paper; a terminal plate 24 to which positive and negative output terminals 25 and 26 are attached; a connection lead unit 27 made of connection leads and insulating paper for connecting the positive and negative terminals of the cell assembly 23 to the positive and negative output terminals 25 and 26; an insulating plate 28; a metal bottom plate 29; and a hollow, square columnar steel outer case 30 for accommodating these parts. The steel outer case 30 accommodates the cell assembly 23, to which the terminal plate 24 has been connected using the connection lead unit 27, the insulating plate 28, and the metal bottom plate 29, and the edge of the bottom open end of the steel outer case 30 is bent inwards to form a crimped part 31 to seal the case. The steel outer case 30 is formed into the hollow, square columnar shape by bending printed and painted steel plate and joining both side edges at a rolled-and-crimped joint 32, where both side edges are rolled and crimped to each other.

FIG. 6 shows an example of the cell 21: A cylindrical positive-electrode mixture pellet 43 principally composed of manganese dioxide and graphite is encased in a positive-electrode case 41 which is an iron cylinder with a bottom. A cylindrical separator 44 with a bottom is set inside the pellet 43, and negative-electrode gel 45 consisting of zinc powder dispersed in electrolyte gel is contained inside. A synthetic resin gasket 46 is coupled onto the open end of the positive-electrode case 41 with its underside abutting the top end of the separator 44, and with the negative-electrode current collector 47 extending through the center of the gasket 46 into the gel 45. A groove 48 is formed at a position a distance below the open end of the positive-electrode case 41 to support the gasket 46, and the open end is bent inwards to crimp seal the case 41. The outer surface of the positive-electrode case 41 is covered by a heat-shrinkable plastic tube 49.

FIG. 7 shows the structure of the cell assembly 23: Six cells 21 are arranged in two rows of three cells each, their positive and negative terminals oriented in opposite directions, to form a group of cells 33. Connection members 22 made of insulating paper 34 and lead pieces 35 secured to the paper are arranged at the top and bottom of the cell group 33, and the lead pieces 35 are spot welded to the positive and negative terminals of the cells 21 through apertures 36 in the insulating paper 34, so that the cells 21 are connected in series and joined in one piece.

The battery pack 20 with the above configuration is not provided with a safety mechanism for each cell 21. In case of a pressure rise in the cells 21 caused by overcharge or overdischarge, or short-circuiting in one or two of the cells 21, the inner pressure will cause deformation in the crimped part of the positive-electrode case 41, which may lead to a release of gas, or possibly, contents of the battery through a gap between the positive-electrode case 41 and the gasket 46 to the outside of the steel outer case 30 of the battery pack 20. For this reason, the steel outer case 30 requires a high safety design to prevent eruption of contents. As shown in FIG. 5, the metal bottom plate 29 is provided with a bent portion 29a at the periphery, which is engaged in radial direction with the crimped part 31 of the steel outer case 30, to create a secure joint. As a consequence, the distance D between the bottom face of the battery pack 20 and the end faces of the cells 21 is large. Since the outer dimensions of the steel outer case 30 are defined by uniform standards, the length of the cells 21, i.e., the internal volume of the cells 21 is smaller by the distance D, which is one factor that inhibits further improvement of battery performance.

Another problem was that because the outer case of the battery pack 20 consists of a steel outer case 30 formed into a hollow square columnar shape with a rolled-and-crimped joint 32 and a metal bottom plate 29, the number of components and process steps is large and a cost reduction is hard to achieve.

### BRIEF SUMMARY OF THE INVENTION

In order to solve the above problems, it is an object of the present invention to provide a battery pack with improved battery performance and reduced cost due to increased inner volume of cells and reduced number of components, a battery pack that secures high safety even in the event of a release of contents from cells.

To achieve the above object, the present invention provides a battery pack comprising: a cell assembly including a plurality of parallel arranged cells that are connected to each other through lead pieces; a planar terminal plate having positive and negative output terminals; and an outer case for accommodating the cell assembly, having one open end at which the terminal plate is arranged, wherein the outer case is a square tubular metal can with a bottom, the open end edge of the metal can is bent inwards to crimp seal the case with the terminal plate, and one or more apertures are formed in a side face of the metal can.

With this configuration, because the outer case is made of a square tubular metal can with a bottom, there exist only an insulating plate and the bottom wall of the metal can between the bottom face of the battery pack and the cell assembly, and because of this reduced distance therebetween, the internal volume of the cells is made larger, which contributes to improved battery performance. Also, because the number of components is reduced, a cost reduction is achieved. Furthermore, one or more apertures in the side face of the metal can will release any gas or contents from the cells to the outside before the pressure may increase too high, causing rupture of the outer case and eruption of the contents to the outside, thus ensuring that high safety standards are met.

The aperture should preferably have an area of 0.2 mm² or more to enable smooth release of gas from the cells to the outside and to prevent rupture of the metal can and eruption of the contents. On the other hand, the aperture area should not exceed 5 mm², so that the presence of apertures does not affect the strength or rigidity of the outer case, and that no foreign matter is allowed to enter, to ensure that high safety standards are met.

The side face of the metal can including the aperture should preferably be printed and painted, so that the paint coat covers the aperture and make the can presentable.

The side face of the metal can including the aperture may be covered by a heat-shrinkable plastic label or tube to make the can presentable and to prevent any gas from gushing out, whereby safety standards are met more reliably.

While novel features of the invention are set forth in the preceding, the invention, both as to organization and content, can be further understood and appreciated, along with other objects and features thereof, from the following detailed description and examples when taken in conjunction with the attached drawings.

### BRIEF DESCRIPTION OF THE DRAWINGS

FIG. 1 is a longitudinal cross-sectional view or a battery pack according to one embodiment of the present invention;

FIG. 2A and FIG. 2B are perspective views of the external appearance of the battery pack viewed from different directions;

FIG. 3A to FIG. 3D are side views illustrating various configuration examples of the aperture provided in the side face of the outer case;

FIG. 4 is a cross-sectional view for explaining the position where the aperture is provided in the side face of the outer case;

FIG. 5 is a longitudinal cross-sectional view of a conventional battery pack;

FIG. 6 is a longitudinal cross-sectional view of a cell; and

FIG. 7 is a perspective view illustrating how a cell assembly is assembled.

### DESCRIPTION OF THE PREFERRED EMBODIMENTS

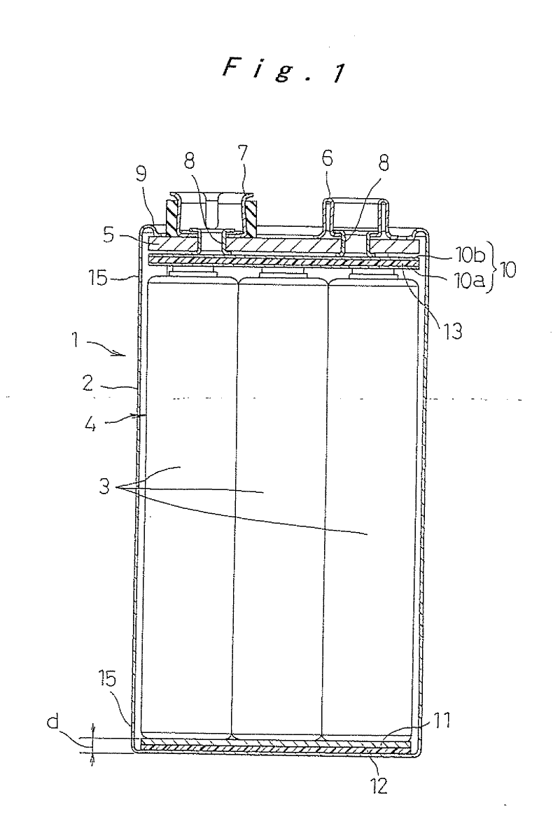

One preferred embodiment of the battery pack of the present invention will be hereinafter described with reference to FIG. 1 to FIG. 4 for the understanding of the invention. The following description is given for illustrating examples of embodiment of the invention and is not intended to limit the scope of the appended claims.

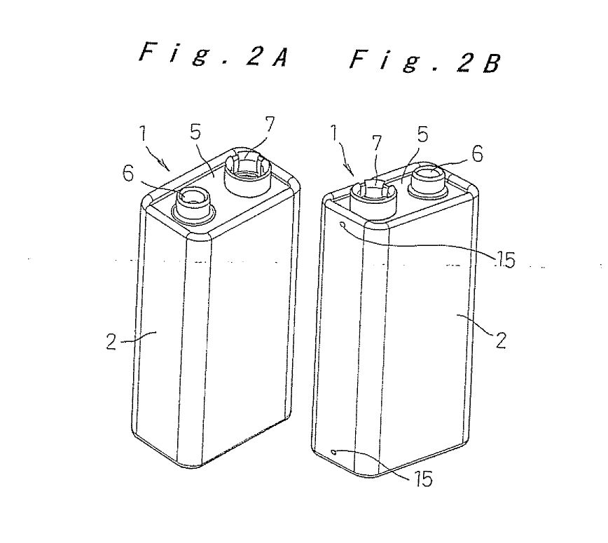

Referring to FIG. 1, FIG. 2A, and FIG. 2B, the battery pack 1 has an outer case 2 which accommodates a cell assembly 4 made of a plurality of cells 3 and a planar terminal plate 5 to which a positive output terminal 6 and a negative output terminal 7 are attached using rivets 8. The open end edge of the outer case 2 is bent inwards to form a crimped part 9, which, together with the terminal plate 5, seals the outer case 2.

The outer case 2 is a square tubular metal can with a bottom. The metal can is produced from steel sheet by punching and drawing: Columnar, oval columnar, or square columnar pieces with a bottom, i.e., cup-like containers are produced from punched-out discs with predetermined dimensions, and drawn into the square columnar shape. The steel sheet may be a nickel-plated steel sheet, painted steel sheet, or plastic laminated steel sheet, and should preferably have a thickness of 0.2 to 0.7 mm in consideration of the strength of the crimp-sealed part and workability of the case. The metal can should preferably be produced to have a bottom wall thickness of 0.2 to 0.7 mm and a side wall thickness of approximately 0.1 to 0.3 mm. For the production of the can, a drawing method or an ironing method should preferably be adopted.

As with the conventional example described with reference to FIG. 7, the cell assembly 4 is made up of six cells 3 arranged in two rows of three cells each, their positive and negative terminals oriented in opposite directions. Upper and lower connection members 10 and 11 made of insulating paper and lead pieces secured to the paper are arranged at the top and bottom of the cells, and the lead pieces are spot welded to the positive and negative terminals of the cells 3 through apertures in the insulating paper, so that the cells 3 are connected in series and joined in one piece.

Between the lower connection member 11 at the bottom of the cell assembly 4 and the bottom wall of the outer case 2 is inserted an insulating paper 12 so as to ensure high insulation between the cell assembly 4 and the outer case 2. Thus the distance d between the end faces of the cells 3 and the bottom face of the outer case 2 is approximately 0.7 to 1.2 mm, which is smaller by 0.4 to 0.6 mm than D in the conventional example, as there are only thin lower connection member 11, the insulating paper 12, and the bottom wall of the outer case 2.

The upper connection member 10 at the top of the cell assembly 4 includes a cell connecting part 10a made of insulating paper and lead pieces for connecting the cells in series and a terminal connecting part 10b for connecting the positive and negative terminals of the cells to the positive and negative output terminals 6 and 7, respectively, these being formed in one piece and folded in two. The upper connection member is arranged between the cells and terminal plate 5, with insulating paper 13 inserted between the folds.

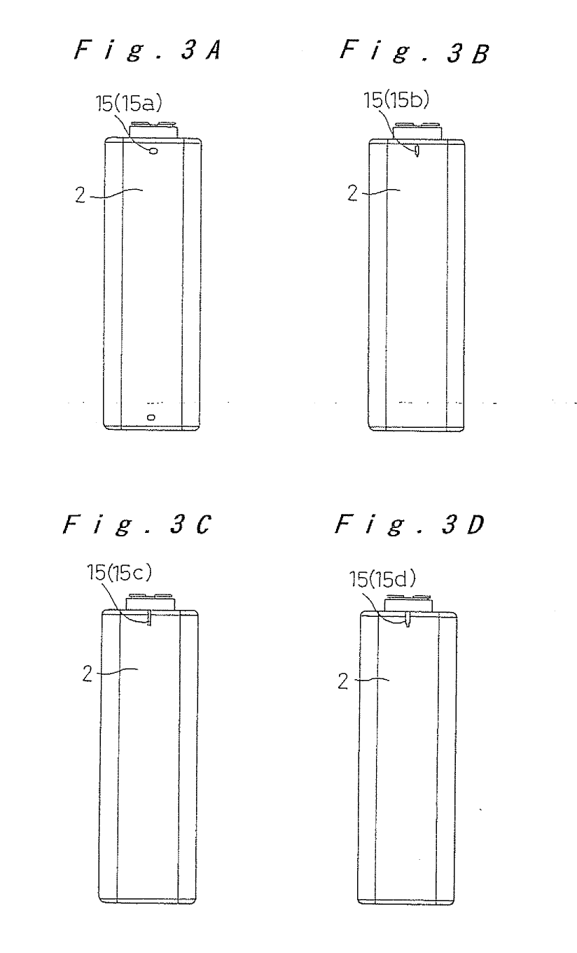

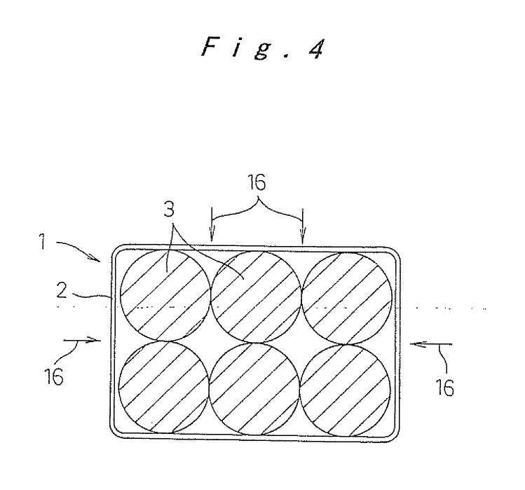

The outer case 2 includes one or more apertures 15 in the side face as shown in FIG. 2B and FIG. 3A (in the illustrated example, two arranged in the upper and bottom parts, respectively). The aperture 15 should preferably be substantially circular having an area of 0.2 mm² or more and not exceeding 5 mm², and is formed by drilling using a pin after the formation of the outer case 2. The outer case 2 is supported with a concave-shaped die on the opposite surface to prevent deformation when the drilling pin is driven into the case 2. As the burrs protruding to the backside of the apertures 15 may scratch the plastic tube cover of the cells 3 and damage insulation when the cell assembly 4 is inserted into the case 2, the apertures 15 must be positioned between the cells 3 or the cell assembly 4, as indicated by the arrows 16 in FIG. 4.

The aperture 15 need not necessarily be a circular hole 15a as shown in FIG. 3A, but may be oval or square, or an ellipse 15b as shown in FIG. 3B or a long slit. Also, it may be a notch 15c cut from the open end edge of the outer case 2 as shown in FIG. 3C, or a notch 15d with a tapered end as shown in FIG. 3D to prevent stress concentration.

The battery pack 1 is assembled as follows: The lead pieces of the cell connecting part 10a are spot welded to the connection terminals at the upper ends of the cells 3, and the lead pieces of the terminal connecting part 10b are spot welded to the positive and negative output terminals 6 and 7 of the terminal plate 5; the insulating paper 13 is inserted between the cell connecting part 10a and the terminal connecting part 10b and the terminal plate 5 is placed on the cell assembly 4; and the lead pieces of the lower connection member 11 are spot welded to the connection terminals at the lower ends of the cells 3, whereby the cell assembly 4 and the terminal plate 5 are assembled together. Next, with the insulating paper 12 abutted on the lower end of the cell assembly 4, the cell assembly 4 and the terminal plate 5 are inserted into the outer case 2, and the open end edge of the outer case 2 is bent inwards to close the outer case 2 with the crimped part 9 and the terminal plate 5; and a heat-shrinkable tube is fitted around the outer case 2 and heat-shrunk, whereby the battery pack 1 is complete.

With this configuration, as the outer case 2 is a square tubular metal can with a bottom, there are only the insulation paper 12 and the bottom wall of the metal can between the bottom face of the battery pack 1 and cell assembly 4, and the internal volume of the cells 3 is increased by the reduced distance d between the end faces of the cells 3 and the bottom face of the battery pack 1. The battery performance is therefore improved, and also a cost reduction is achieved because of the reduced number of components.

As the outer case 2 includes one or more apertures 15 in the side face (preferably having an area of 0.2 mm² or more), even if the cell 3 releases gas or its contents, the aperture 15 will let off the gas to the outside smoothly enough before the internal pressure may climb too high, causing rupture of the outer case 2 and eruption of the contents to the outside, and thus high safety standards are met. The aperture 15 has an area not exceeding 5 mm² so that it does not affect the strength or rigidity of the outer case 2 and does not allow entrance of foreign matter from outside, to ensure that high safety standards are met.

The side face of the outer case 2 including the apertures 15 is covered by the heat-shrinkable plastic tube (not shown), which not only makes the case presentable but also prevents gas from gushing out, so that battery safety is further improved. Instead of covering the case with the plastic tube, a plastic label may be bonded to the case, or the case may be printed and painted.

### EXAMPLES

Next, specific examples of embodiment of the present invention and comparative examples will be described.

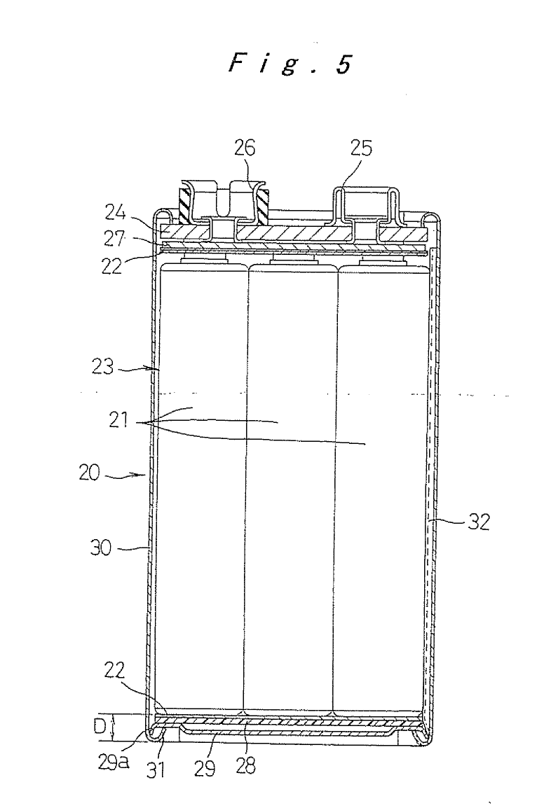

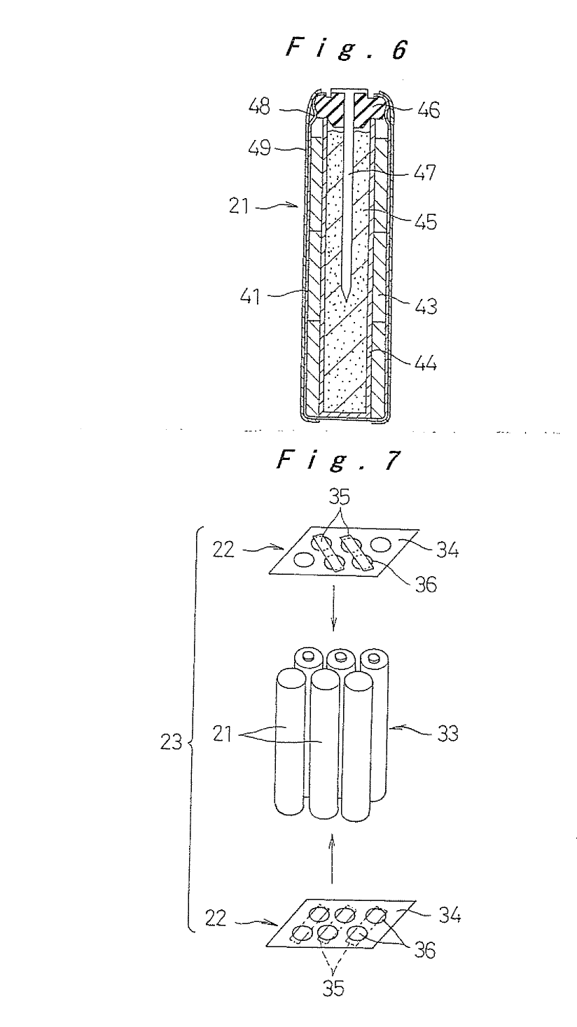

As first to fifth examples, five types of battery packs 6LR61 made up of the outer case 2, cell assembly 4 consisting of six LR61 cells, and terminal plate 5, as shown in FIG. 1, were produced. Example 1 had one aperture 15 with the size of 0.1 mm^{2,} Example 2 had one aperture 15 with the size of 0.2 mm², Example 3 had one aperture 15 with the size of 0.3 mm², Example 4 had two apertures 15 with the size of 0.1 mm², and Example 5 had two apertures 15 with the size of 0.2 mm². As a comparative example (Comparative Example 1), a battery pack with the same configuration as the conventional example shown in FIG. 5 (with a 0.2 mm thick steel outer case 30) was produced, and as another comparative example (Comparative Example 2), a battery is pack with the same basic configuration as the above examples of the invention but without any aperture 15. The cells in the examples other than Comparative Example 1, in which a can with a bottom was used, were 0.4 mm longer.

The above examples of the invention and the comparative examples were subjected to the following tests for evaluation: One of the cells in the battery pack was short-circuited, and two of the cells were short-circuited, respectively at room temperature and at 45° C. The batteries were discharged with a constant resistance of 180 Ω, and the duration of time until the terminal voltage of 5.4V was reached was measured, the results being evaluated relative to 100 of Comparative Example 1.

TABLE 1

| | | | | Evaluation Results | | | | |
|---|---|---|---|---|---|---|---|---|
| | | | | Room Temperature | | Temperature: 45° C. | | |
| | Conditions | | | One Cell | Two Cell | One Cell | Two Cell | Duration of Discharge |
| | | | Aperture | Short- | Short- | Short- | Short- | (Constant Resistance: |
| | Outer Case | Number of | Area | Circuiting | Circuiting | Circuiting | Circuiting | 180 Ω) until Terminal |
| | Shape | Aperture | (mm²) | Test | Test | Test | Test | Voltage 5.4 V |
| Example 1 | Case with a | 1 | 0.1 | ◯ | ◯ | ◯ | X(Note 2) | 105 |
| | Bottom | | | | | | | |
| Example 2 | ↓ | 1 | 0.2 | ◯ | ◯ | ◯ | ◯ | ↓ |
| Example 3 | ↓ | 1 | 0.3 | ◯ | ◯ | ◯ | ◯ | ↓ |
| Example 4 | ↓ | 2 | 0.1 | ◯ | ◯ | ◯ | X(Note 2) | ↓ |
| Example 5 | ↓ | 2 | 0.2 | ◯ | ◯ | ◯ | ◯ | ↓ |
| Comparative | Tubular | None | None | ◯ | X(Note 1) | ◯ | X(Note 1) | 100 |
| Example 1 | Case | | | | | | | |
| Comparative | Case with a | None | None | ◯ | ◯ | ◯ | X(Note 2) | 105 |
| Example 2 | Bottom | | | | | | | |

Table 1 shows the evaluation results and measurement results of the examples of the invention and the comparative examples. “O” indicates that no problems were found. “X(Note 1)” indicates that part of the bottom plate at the bottom curled and came off, and “X(Note 2)” indicates that part of the terminal plate at the top curled and came off.

Table 1 shows the following: No problems were found in all examples and comparative examples in the one cell short-circuiting test, but in the two cell short-circuiting test, the bottom plate came off in Comparative Example 1 both at room temperature and at 45° C. In the two cell short-circuiting test, the terminal plate at the top came off in Examples 1 and 4 and in Comparative Example 2. Examples 2, 3 and 5 exhibited good results in all conditions. All examples which used a can with a bottom, as compared to Comparative Example 1, had 5% improved discharge characteristics.

According to the present invention, the use of a square tubular metal can with a bottom for the outer case reduces the distance between the bottom face of the battery pack and the cell assembly, and the internal volume of the cells is increased by the reduced distance and the battery performance is accordingly improved. Also, a cost reduction is achieved because of the reduced number of components. Furthermore, one or more apertures in the side face of the metal can reliably prevents abnormal inner pressure rise which may lead to rupture of the outer case and eruption of the contents, and high safety standards are thus met.

Although the present invention has been fully described in connection with the preferred embodiment thereof, it is to be noted that various changes and modifications apparent to those skilled in the art are to be understood as included within the scope of the present invention as defined by the appended claims unless they depart therefrom.

What is claimed is:

1. A battery pack comprising:
a cell assembly including a plurality of parallel arranged cells that are connected to each other through lead pieces;
a planar terminal plate having positive and negative output terminals; and
an outer case for accommodating the cell assembly, having one open end at which the terminal plate is arranged,
wherein the outer case is a square tubular metal can with a bottom, the open end edge of the metal can is bent inwards to crimp seal the case with the terminal plate, and one or more apertures are formed in a side face of the metal can.

2. The battery pack according to claim 1, wherein the aperture has an area of 0.2 mm² or more and 5 mm² or less.

3. The battery pack according to claim 1, wherein the side face of the metal can including the aperture is printed and painted.

4. The battery pack according to claim 1, wherein the side face of the metal can including the aperture is covered by any one of a heat-shrinkable plastic label and a heat-shrinkable plastic tube.
